(19) United States
(12) Patent Application Publication
(10) Pub. No.: US 2016/0103433 A1
(43) Pub. Date: Apr. 14, 2016

(54) SYSTEM AND METHOD TO PROVIDE AN INTELLIGENT PIPELINE MANAGEMENT GRAPHICAL USER INTERFACE MAP DISPLAY

(71) Applicant: General Electric Company, Schenectady, NY (US)

(72) Inventors: Urvashi Sahni, San Ramon, CA (US); R K Raju Mudunuru, Dublin, CA (US); Sudhakar Y. Reddy, San Ramon, CA (US); Purushothama Reddy Aluri, San Ramon, CA (US)

(21) Appl. No.: 14/509,213

(22) Filed: Oct. 8, 2014

(51) Int. Cl. G05B 15/02; G06F 17/30; G06F 3/0484

(52) U.S. Cl. CPC G05B 15/02; G06F 3/0484; G06F 17/30864

(57) ABSTRACT

A pipeline status database may store information about the current status of a plurality of pipeline portions comprising a pipeline, each pipeline portion being adapted to transport a substance. An intelligent pipeline monitoring platform coupled to the pipeline status database may include a mapping module to automatically determine location information associated with each of the plurality of pipeline portions and a graphical user interface module having access to real world map information. A communication port coupled to intelligent pipeline monitoring platform may transmit information to create for a user a visual representation of the plurality of pipeline portions, including information about the current status of at least one pipeline portion, on a graphical user interface map display in accordance with the location information.

### BACKGROUND

Pipelines may be used to transport a substance from one location to another. For example, a pipeline may be used to transport propane gas from one location to another location hundreds of miles away. At any given time, various portions of a pipeline may be at risk of malfunctioning, either due to corrosion, mechanical damage, equipment failures, etc. As a result, an enterprise operating a pipeline may need to manage the pipeline to fix anomalies as they arise. For example, an enterprise might assign a work order to a field crew to address internal corrosion that has been detected in the pipeline. Manually managing these various pipeline risks, however, can be a time consuming, difficult, and error prone process. Moreover, it can be difficult for a user to visualize relationships between physical pipeline locations and various types of risk, especially when there are a substantial number of pipeline segments and/or pipeline assets (or even when an enterprise is operating multiple pipelines). It would therefore be desirable to provide systems and methods to provide an intelligent pipeline management graphical user interface map display in an automatic and accurate manner.

### BRIEF DESCRIPTION OF THE DRAWINGS

FIG. 1 is a high-level architecture of a system in accordance with some embodiments.

FIG. 2 illustrates a method that might be performed according to some embodiments.

FIG. 3 illustrates an intelligent pipeline management enterprise dashboard display according to some embodiments.

FIG. 4 illustrates an intelligent pipeline management map display in accordance with some embodiments.

FIG. 5 illustrates an intelligent pipeline management notification display according to some embodiments.

FIG. 6 illustrates an intelligent pipeline management segment integrity display in accordance with some embodiments.

FIG. 7 illustrates an intelligent pipeline management potential impact radius display according to some embodiments.

FIG. 8 illustrates an intelligent pipeline management street view display in accordance with some embodiments.

FIG. 9 illustrates an intelligent pipeline management risk display according to some embodiments.

FIG. 10 illustrates another intelligent pipeline management risk display in accordance with some embodiments.

FIG. 11 illustrates an intelligent pipeline management anomaly display according to some embodiments.

FIG. 12 illustrates an intelligent pipeline management work order display in accordance with some embodiments.

FIG. 13 is block diagram of an intelligent pipeline management platform according to some embodiments of the present invention.

FIG. 14 is a tabular portion of a pipeline segment database according to some embodiments.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

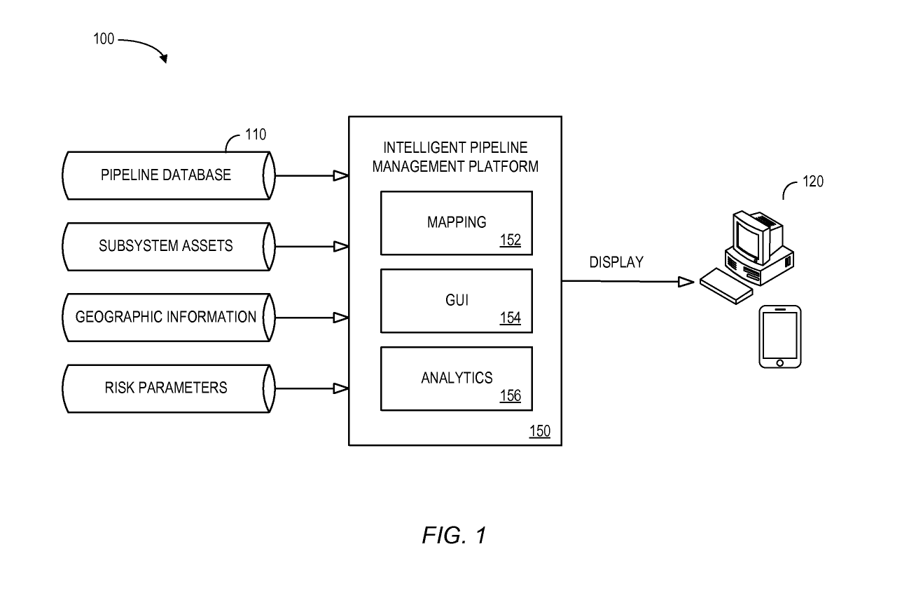

FIG. 1 is a high-level architecture of a system 100 in accordance with some embodiments. The system 100 includes data sources 110 that provide information to an intelligent pipeline management platform 150. The data sources 110 might include, for example a pipeline database storing current and/or historical information about one or more pipeline and/or segments of a pipeline. According to some embodiments, the data sources 110 include information about subsystem assets, such as pipeline compressor stations, main line valves, meters, etc. The data sources 110 may further include geographic information, such as map data, topographical data, etc. According to some embodiments, the geographic information may be associated with satellite data and/or a Geographic Information System (“GIS”) that captures, stores, manipulates, analyzes, manages, and/or presents various types of spatial or geographical data. The data sources 110 may also include risk parameter information, including weather and seismic related risk parameters.

The intelligent pipeline management platform 150 may, according to some embodiments, access the data sources 110, execute a mapping module 152, a graphical user interface module 154, and/or an analytics module 156 (e.g., associated with risk prediction), and automatically generate displays for various user platforms 120 as appropriate. As used herein, the term “automatically” may refer to, for example, actions that can be performed with little or no human intervention.

As used herein, devices, including those associated with the system 100 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The intelligent pipeline management platform 150 may store information into and/or retrieve information from the data sources 110 and/or user platforms 120. The data sources 110 may be locally stored or reside remote from the intelligent pipeline management platform 150. Although a single intelligent pipeline management platform 150 is shown in FIG. 1, any number of such devices may be included. Moreover, various devices described herein might be combined according to embodiments of the present invention. For example, in some embodiments, the intelligent pipeline management platform 150 and data sources 110 might comprise a single apparatus.

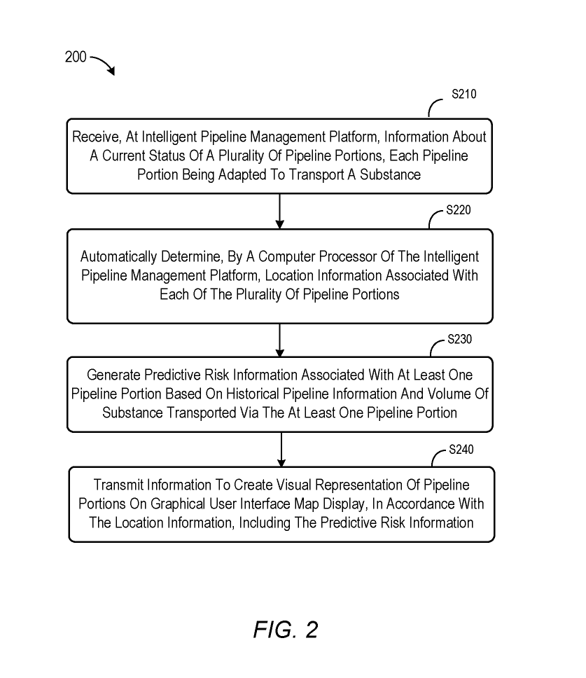

A user may access the system 100 via one of the user platforms 120 (e.g., a personal computer, tablet, or smartphone) to view information about and/or manage a pipeline in an automatic and accurate manner in accordance with any of the embodiments described herein. For example, FIG. 2 illustrates a method 200 that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an intelligent pipeline monitoring platform may receive information about the current status of a plurality of pipeline portions comprising a pipeline, each pipeline portion being adapted to transport a substance. The pipeline portions might transport, for example, a gas (such as propane) or a liquid (such as crude or refined oil). As used herein, the phrase “pipeline portion” may refer to, for example, an actual pipe or anything associated with a pipeline, such as a compressor station, a main line valve, a field crew, and/or a pipeline meter.

At S220, a mapping module may automatically determine location information associated with each of the plurality of pipeline portions. As used herein, the phrase “location information” might refer to, for example, pixels (e.g., a location on a display monitor), coordinates, latitudes and longitudes, Global Positioning System (“GPS”) information, distances (e.g., along the pipeline), and/or GIS data.

At S230, an analytic module, having access to historical pipeline information, may generate predictive risk information associated with at least one of the pipeline portions. The predictive risk value is based at least in part on a volume of substance transported via the at least one pipeline portion. For example, if prior compressor stations have typically failed after transported a certain amount of gas the analytic module might predict that a compressor station in a pipeline is likely to fail in the near future. The predictive risk information might be output as a value, a category (e.g., “high” or “low” risk), a percentage (representing a likelihood of failure), and/or a color (e.g., with “green” indicating low risk, “yellow” indicating moderate risk, and “red” indicating high risk). A risk parameter might be associated with, for example, a corrosion pipeline wall thickness loss, a pressure change, weather and flood risk, earthquake risk, mechanical damage, and/or pipeline dent risk.

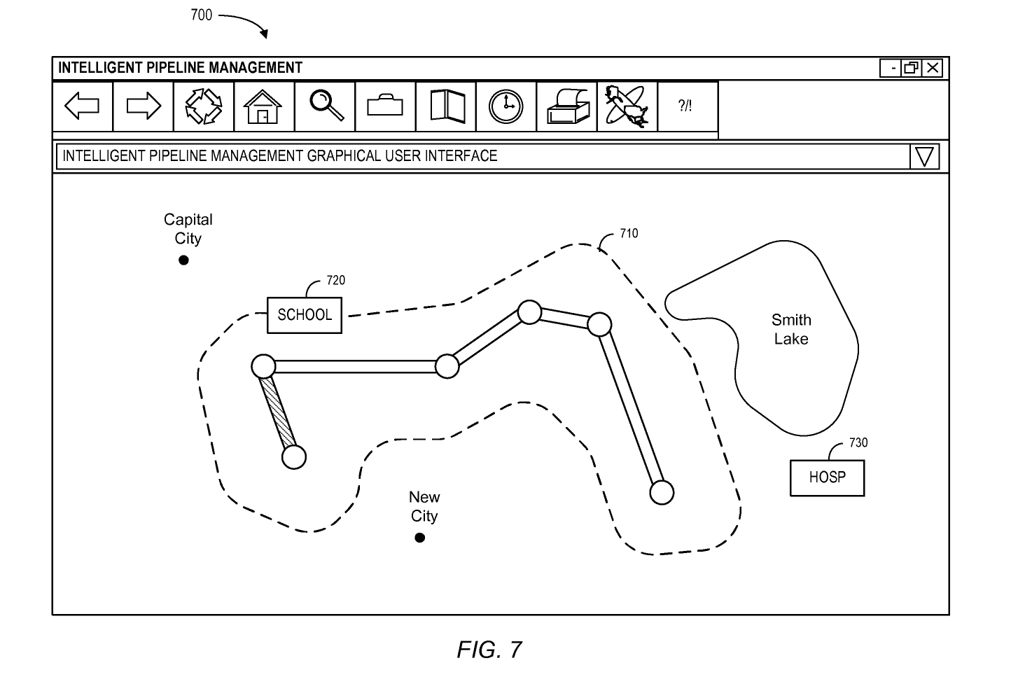

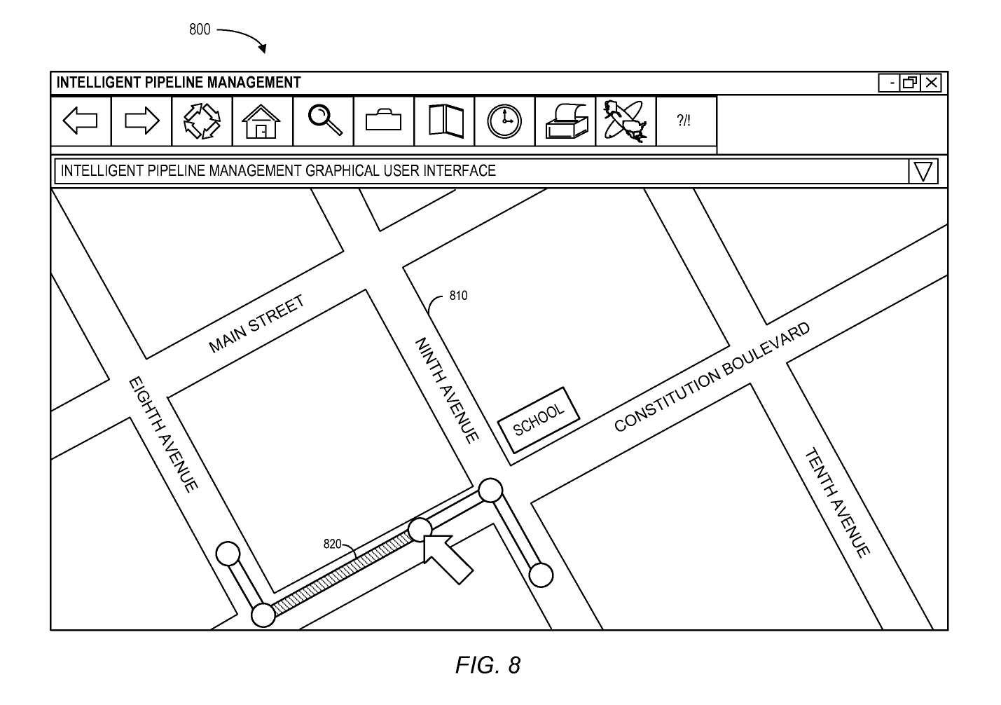

At S240, a graphical user interface module having access to real world map information may arrange to transmit information creating for a user a visual representation of the plurality of pipeline portions, including information about the current status of at least one pipeline portion, on a graphical user interface map display in accordance with the location information. The graphical user interface map display may further include, for example, topographical information, a geographic feature (e.g., a mountain, ravine, or lake), street information (as described with respect to FIG. 8), population information, weather information, seismic information, building information, and/or predicted impact radius information (as described with respect to FIG. 7). Note that the information generated by the graphical user interface module may be adapted to create the visual representation in accordance with a number of different display platforms, including different types of hardware configurations, Operating Systems (“OS”), etc.

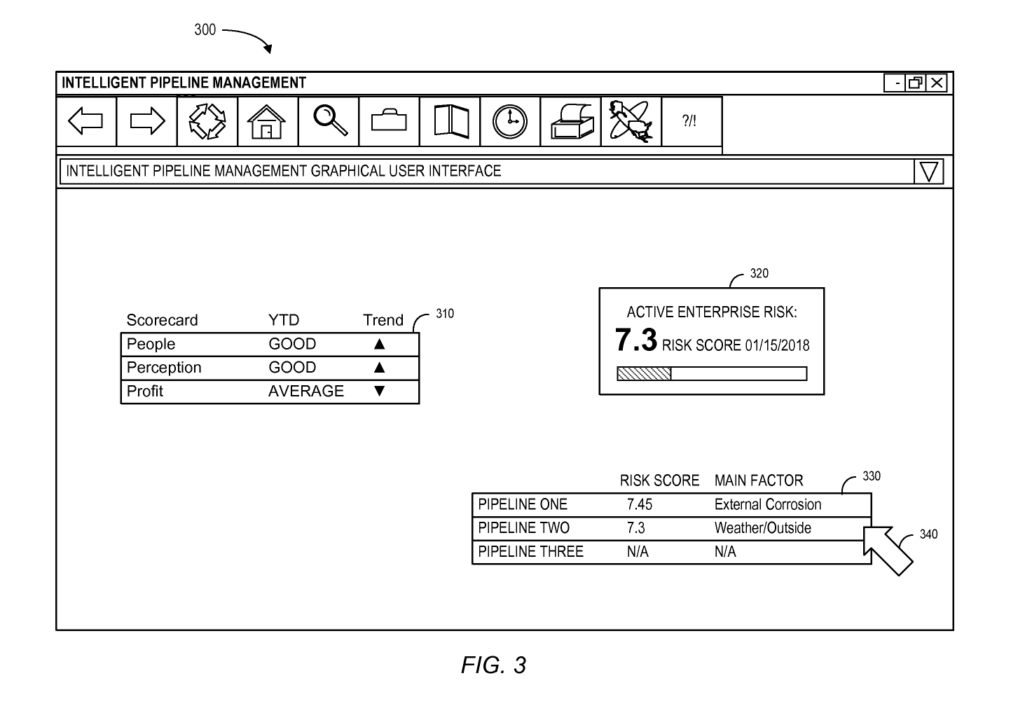

According to some embodiments, the graphical user interface map display further includes an enterprise level active risk value associated with a plurality of different pipelines. For example, FIG. 3 illustrates an intelligent pipeline management enterprise dashboard display 300 according to some embodiments. The display 300 may include a scorecard area 310 providing overall information about the enterprise, including, for example, the status of current profit, an enterprise stock price graph, etc. The display 300 may also include an active enterprise risk area 320 representing an overall current amount of risk associated with the enterprise. The display 300 may also include a detailed risk score area 330 displaying individual risk information about a number of different pipelines.

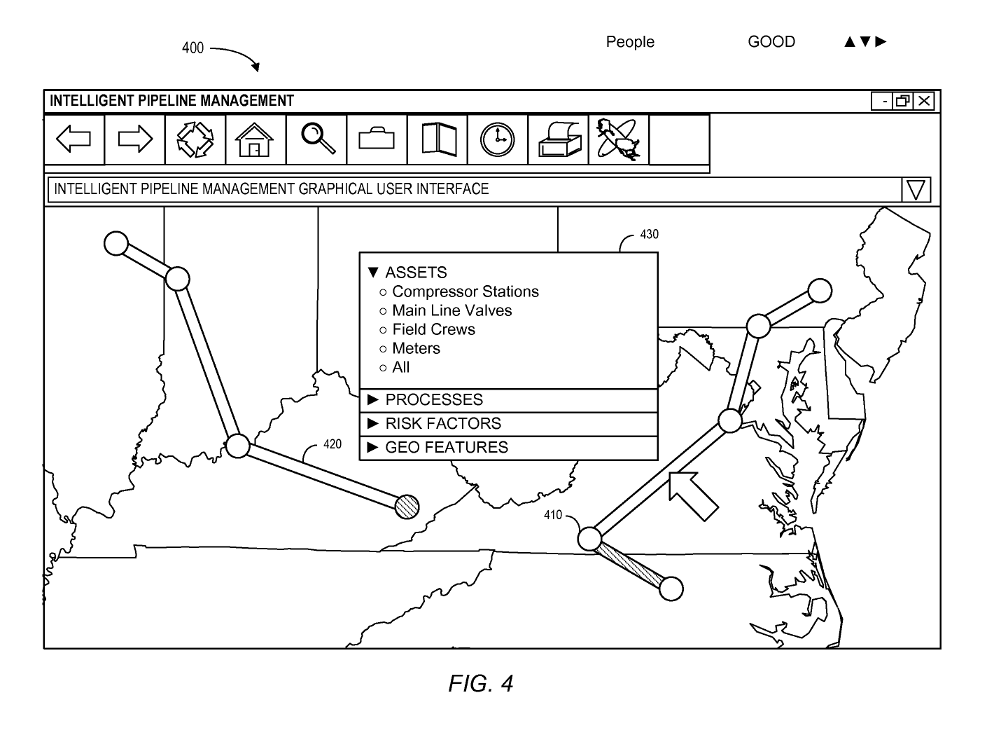

According to some embodiments, a user may select one of the pipelines in the detailed risk score area 330 (e.g., with his or her computer mouse pointer icon 340) to view more information about that particular pipeline. For example, FIG. 4 illustrates an intelligent pipeline management map display 400 in accordance with some embodiments. In particular, the display 400 illustrated in FIG. 4 includes a map overlaid with graphical representations of two pipelines 410, 420. The pipelines 410, 420 include actual pipe segments along with other pipeline assets. Note that risk information about various segments of the pipelines 410, 420 may also be included on the display 400 (e.g., low risk segments may be displayed as green or high risk segments may be displayed with crosshatching as illustrated in FIG. 4). According to some embodiments a filter area 430 may let a user add or remove various assets and/or other information from the display 400.

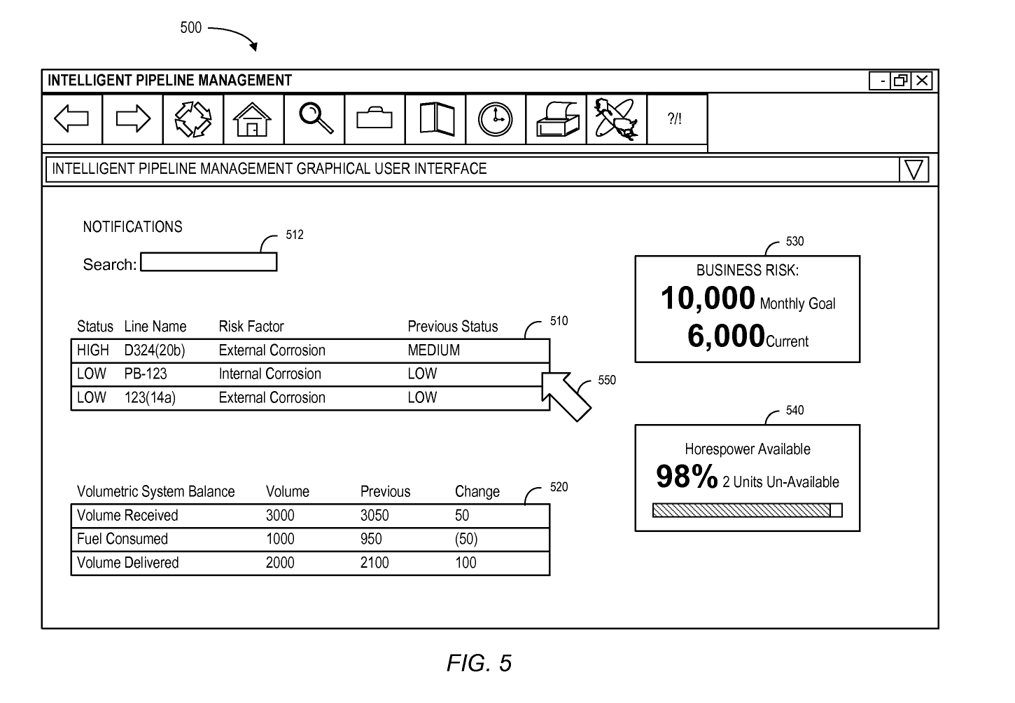

FIG. 5 illustrates an intelligent pipeline management notification and/or change log display 500 according to some embodiments. The display 500 includes a notification area 510 providing the status, line name, risk factor and/or previous status of each notification. According to some embodiments, a user may enter a search term in a search box 512 to find a particular notification. The display 500 may further provide volumetric system balance information 520, including current and past amounts of substance received, consumed, delivered, blown-down, purged, etc. According to some embodiments, the display includes a business risk area 530 (e.g., comparing a business goal with a current amount) and/or an available horsepower area 540 indicating a number of units that may be presently unavailable.

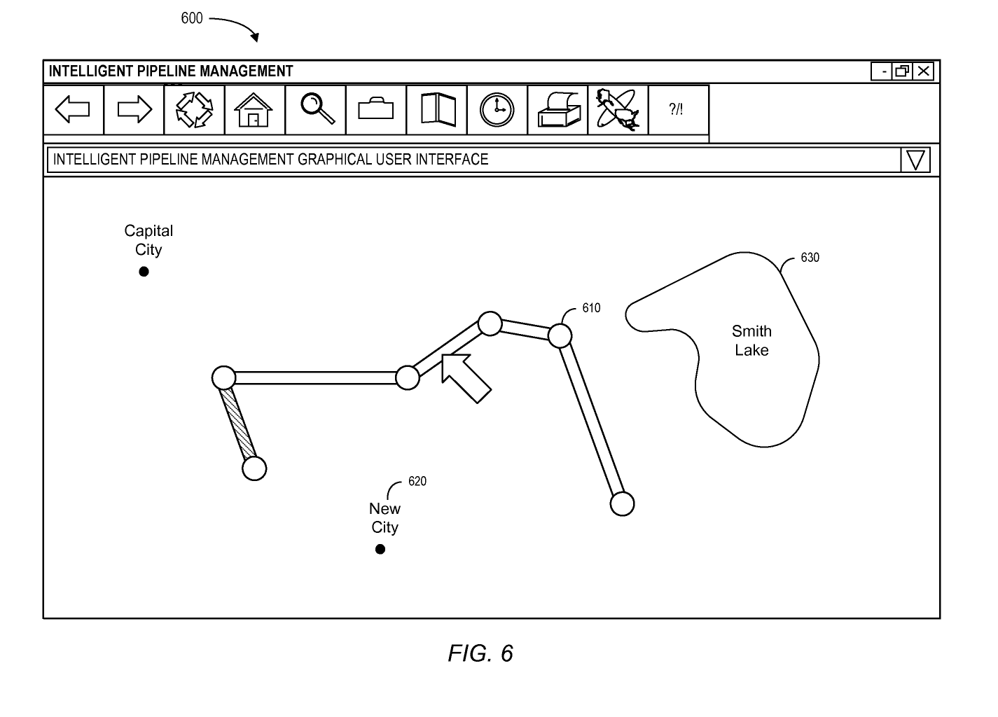

FIG. 6 illustrates an intelligent pipeline management segment integrity display 600 in accordance with some embodiments. In particular, the display 600 illustrated in FIG. 6 includes a map overlaid with a graphical representation of a pipeline 610. The pipeline 610 includes actual pipe segments along with other pipeline assets. Note that risk information about various segments of the pipeline 610 may also be included on the display 600 (e.g., low risk segments may be displayed as green or high risk segments may be displayed with crosshatching as illustrated in FIG. 6). According to some embodiments the display 600 further includes information about population centers 610 (e.g., cities and towns), geographic features 630, highways, weather patterns, wildfires, etc.

To help understand the criticality of safety and impact of adverse events in a pipeline network, the system may calculate a Potential Impact Radius (“PIR”) associated with a pipeline and/or pipeline segments. FIG. 7 illustrates an intelligent pipeline management potential impact radius display 700 according to some embodiments. As before, the display 700 illustrated in FIG. 7 includes a map overlaid with a graphical representation of a pipeline and the associated PIR 710 (illustrated with a dotted line in FIG. 7), including actual pipe segments and other pipeline assets. Note that risk information about various segments of the pipeline 610 may also be included on the display 700 (e.g., low risk segments may be displayed as green or high risk segments may be displayed with crosshatching as illustrated in FIG. 7). According to some embodiments the display 700 further includes information about population centers (e.g., cities and towns), geographic features, and other specific areas that may be of concern, such as a school 720, a hospital 730, etc.

FIG. 8 illustrates an intelligent pipeline management street view display 800 in accordance with some embodiments. In this example, the display 800 includes a street 810 level map overlaid with a graphical representation of a pipeline 820, including actual pipe segments and other pipeline assets. Note that risk information about various segments of the pipeline 610 may also be included on the display 800 (e.g., high risk segments may be displayed as red or with crosshatching as illustrated in FIG. 8). According to some embodiments the display 800 further includes information about geographic features, current traffic data, and other specific areas that may be of concern, such as a school, a hospital, a playground, etc.

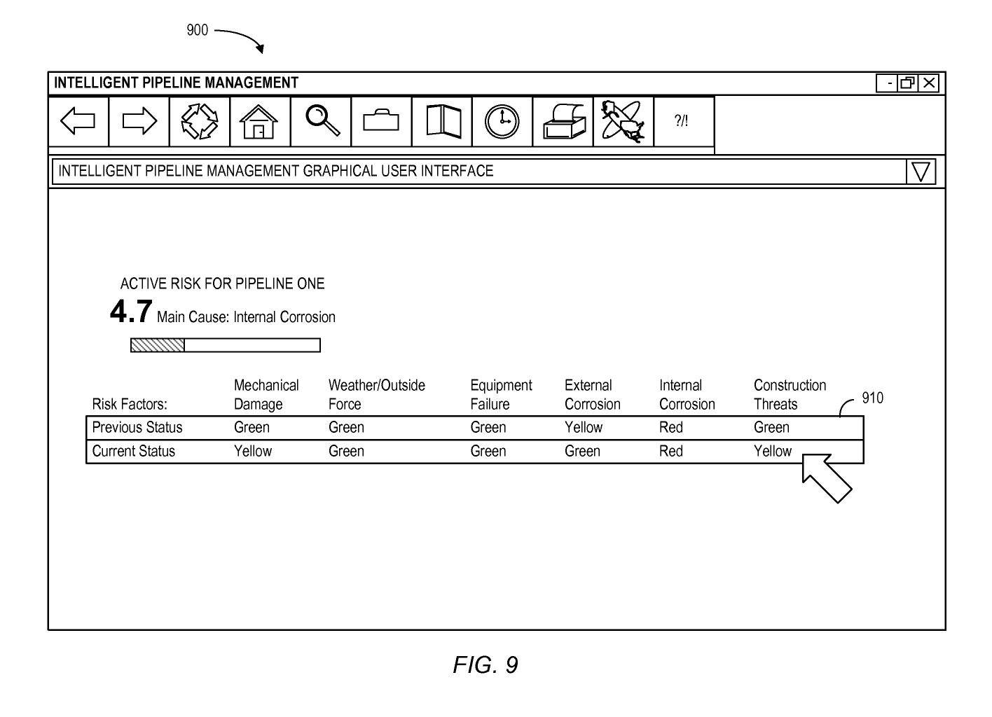

According to some embodiments, selection of a pipeline 810 or pipeline segment on a display may provide more detailed risk information associated with that pipeline 810 or pipeline segment. For example, FIG. 9 illustrates an intelligent pipeline management risk display 900 according to some embodiments. The display 900 includes an overall active risk score of a pipeline (along with an explanation of the main cause of that risk). A risk detail area 910 may provide current and prior risk statuses (e.g., with green indicating low risk, yellow indicating moderate risk, and red indicating high risk) for various risk factors. The risk factors in the risk area 910 might include, for example, various categories and types of risk, such as mechanical damage, weather/outside force risks, equipment failure, external corrosion, internal corrosion, construction threats, manufacturing material risk, Stress Corrosion Cracking (“SCC”), etc.

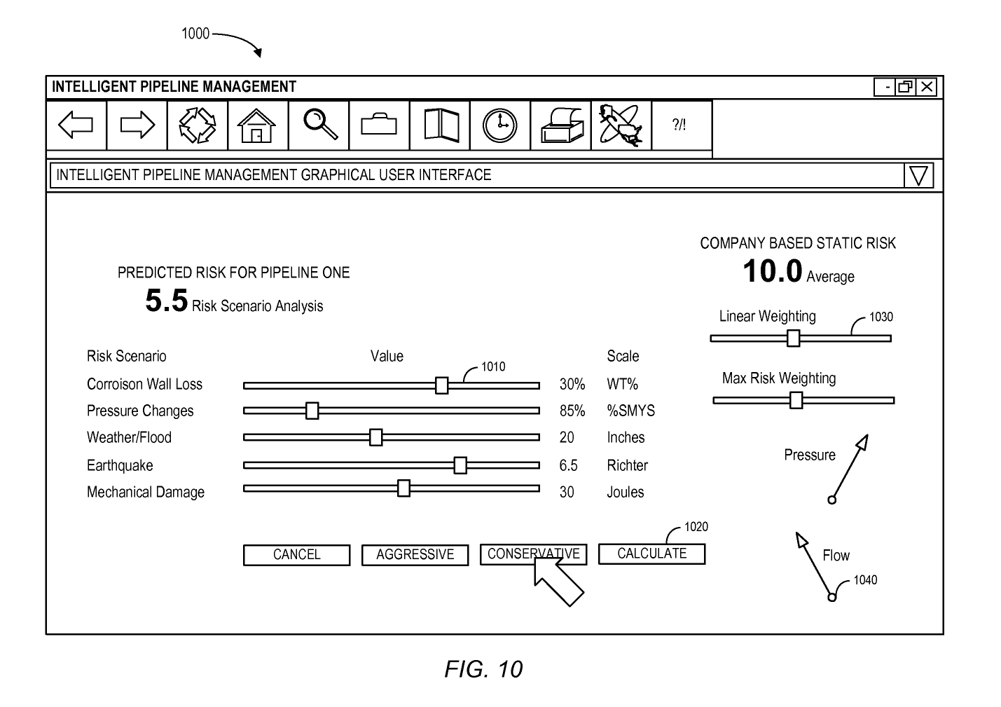

Other types of risk information may also be provided in connection with the intelligent pipeline management system disclosed herein. For example, FIG. 10 illustrates another intelligent pipeline management risk display 1000 in accordance with some embodiments. This risk display 1000 includes a user control portion 1010 where a user can adjust various risk assumptions. For example, a user control module may receive weighing values for a risk scenario used by an analytic module via the user control portion 1010. In particular, a user might slide a graphical control to input values associated with corrosion wall thickness loss, operations/pressure changes, weather/flood/volume, outside force/earthquake, mechanical damage/impact, and/or mechanical damage/dent. The analytics module may then calculate a predicted risk score based on the user inputs. According to some embodiments, a user might select icons 1020 to automatically populate the risk parameters with aggressive or conservative assumptions. The risk display 1000 may also include a company based static risk area 1030 along with linear weighting and maximum risk weighting information. The risk display 1000 may further include representations of dials or gauges to convey pressure information, flow information, etc.

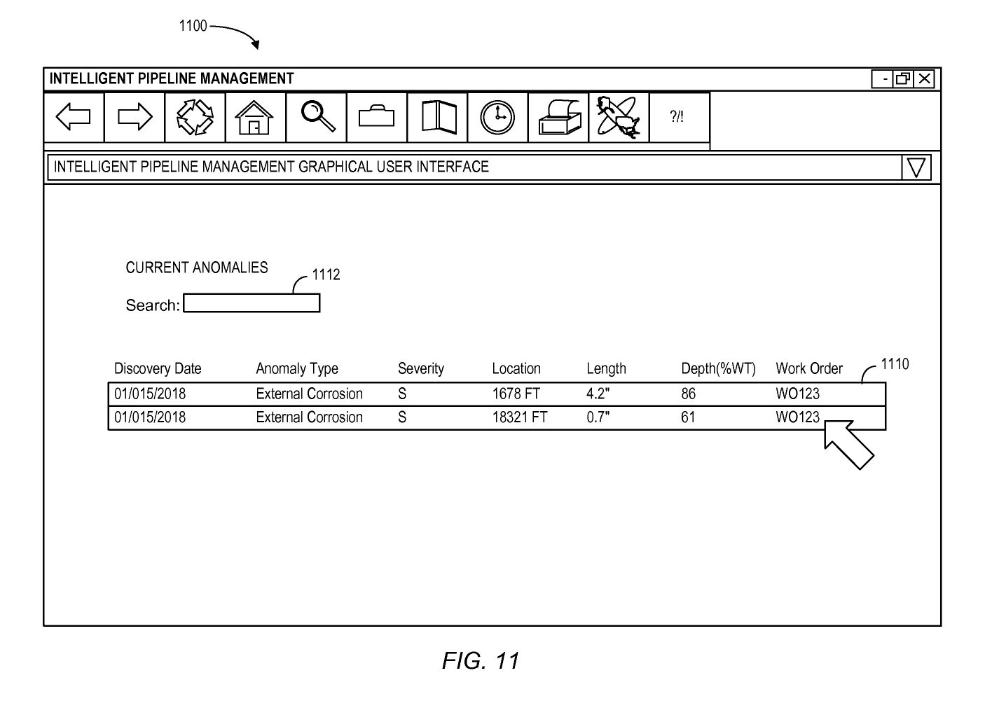

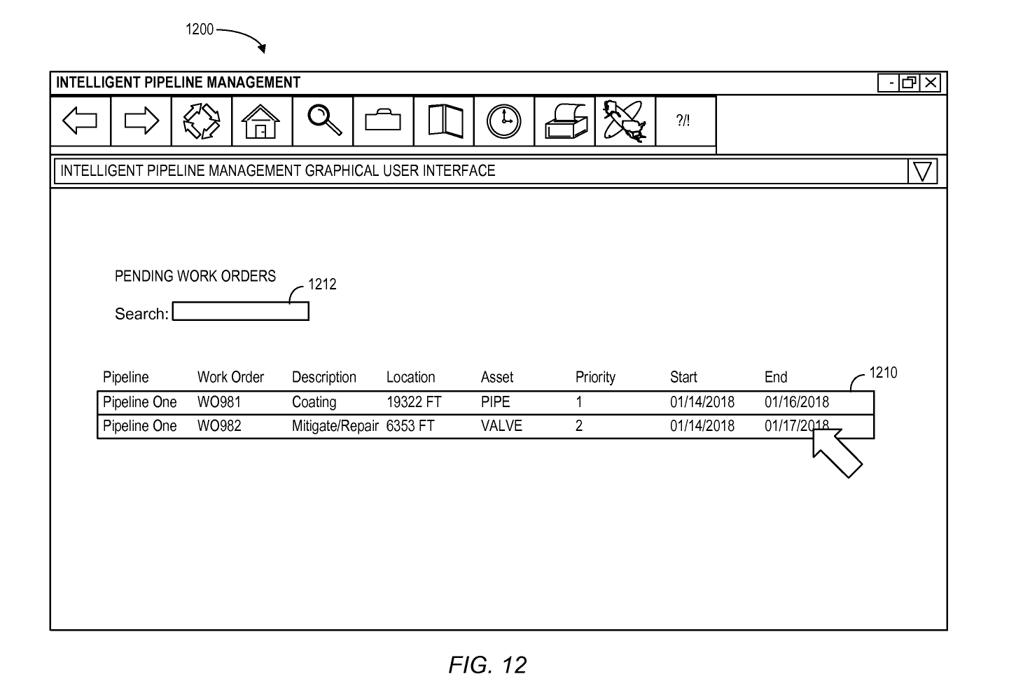

FIG. 11 illustrates an intelligent pipeline management anomaly display 1100 according to some embodiments. According to some embodiments, a user may enter a search term in a search box 1112 to find a particular anomaly. A current anomaly area 1110 may provide, for example, a discovery date, an anomaly type, a severity level or class, a location, a depth, etc. Responsive to the discovery of an anomaly, a user or enterprise might assign a work order to have a field crew address the risk. FIG. 12 illustrates an intelligent pipeline management work order display 1200 in accordance with some embodiments. According to some embodiments, a user may enter a search term in a search box 1212 to find a particular work order. A work order area 1210 may provide, for example, a pipeline name or identifier, a work order number or identifier, a description of an anomaly, a location, a description of an asset, a priority lever, a start date indicating when the work order was opened, an end date when the risk was addressed, etc.

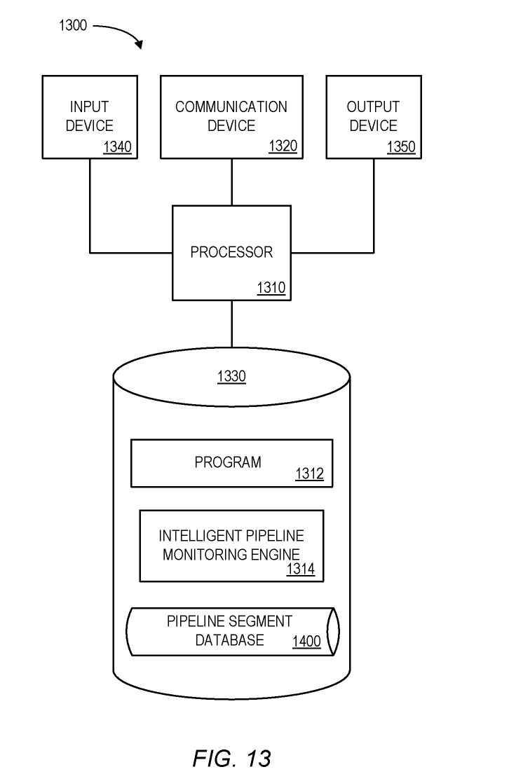

The embodiments described herein may be implemented using any number of different hardware configurations. For example, FIG. 13 is block diagram of an intelligent pipeline management platform 1300 that may be, for example, associated with the system 100 of FIG. 1. The intelligent pipeline management platform 1300 comprises a processor 1310, such as one or more commercially available Central Processing Units (CPUs) in the form of one-chip microprocessors, coupled to a communication device 1320 configured to communicate via a communication network (not shown in FIG. 13). The communication device 1320 may be used to communicate, for example, with one or more remote user platforms. The intelligent pipeline management platform 1300 further includes an input device 1340 (e.g., a computer mouse and/or keyboard to input adaptive and/or predictive modeling information) and an output device 1350 (e.g., a computer monitor to display alerts and/or reports). According to some embodiments, a mobile device and/or voice activated messages may be used to exchange information with the intelligent pipeline management platform 1300.

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or an intelligent pipeline monitoring engine 1314 for controlling the processor 1310. The processor 1310 performs instructions of the programs 1312, 1314, and thereby operates in accordance with any of the embodiments described herein. For example, the processor 1310 may receive information about the current status of a plurality of pipeline portions comprising a pipeline, each pipeline portion being adapted to transport a substance. The processor 1310 may include a mapping module to automatically determine location information associated with each of the plurality of pipeline portions and a graphical user interface module having access to real world map information. The processor 1310 may also arrange for a transmission of information to create for a user a visual representation of the plurality of pipeline portions, including information about the current status of at least one pipeline portion, on a graphical user interface map display in accordance with the location information.

The programs 1312, 1314 may be stored in a compressed, uncompiled and/or encrypted format. The programs 1312, 1314 may furthermore include other program elements, such as an operating system, clipboard application a database management system, and/or device drivers used by the processor 1310 to interface with peripheral devices.

As used herein, information may be “received” by or “transmitted” to, for example: (i) the intelligent pipeline management platform 1300 from another device; or (ii) a software application or module within the intelligent pipeline management platform 1300 from another software application, module, or any other source.

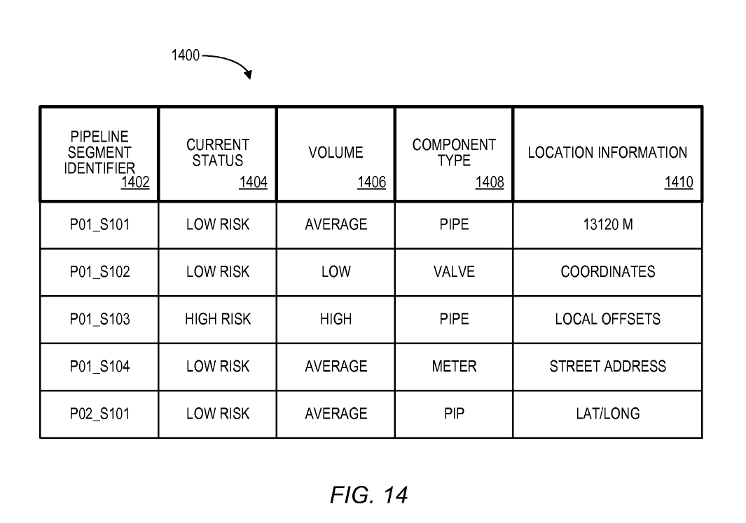

In some embodiments (such as shown in FIG. 13), the storage device 1330 stores a pipeline segment database 1400. An example of a database that may be used in connection with the intelligent pipeline management platform 1300 will now be described in detail with respect to FIG. 14. Note that the database described herein is only one example, and additional and/or different information may be stored therein. Moreover, various databases might be split or combined in accordance with any of the embodiments described herein.

Referring to FIG. 14, a table is shown that represents the pipeline segment database 1400 that may be stored at the intelligent pipeline management platform 1300 according to some embodiments. The table may include, for example, entries identifying pipes and other pipeline assets associated with one or more pipelines. The table may also define fields 1402, 1404, 1406, 1408, 1410 for each of the entries. The fields 1402, 1404, 1406, 1408, 1410 may, according to some embodiments, specify: a pipeline segment identifier 1402, a current status 1404, a volume amount 1406, a component type 1408, and location information 1410. The component database 1400 may be created and updated, for example, when an intelligent pipeline management platform is created and/or as information is received from a field crew, etc.

The pipeline identifier 1402 may be, for example, a unique alphanumeric code identifying a particular pipeline along with a particular portion of pipe or other pipeline asset. The current status might indicate an actual or predicted level of risk for that segment. The volume 1406 might be numerical value or category describing an amount of substance being transported via that segment (which may be used by an analytics module to generate a predicted risk in view of historical information). The component type 1408 may described the component and the location information 1410 may be used to help render a representation of that pipeline segment on a map display.

Thus, some embodiments may provide an automatic and efficient way of displaying pipeline location and/or risk information to a user. Embodiments may provide a unique interface consolidating functionality and view data on different display and/or platforms to make user interaction simple and efficient. According to some embodiments, an integrate modal (or “popup”) windows may provide integrity data, enabling users to view both the location/street environment of pipeline assets and/or a three dimensional visualization of anomalies and structural risks within a pipeline segment. Moreover, a geospatial view of a pipeline network and associated assets may enable convergence of disparate data sets (e.g., compressor stations, valves, and critical local structures such as schools) in one location for network awareness and understanding. Some embodiments may let a user preserve the layering and filtering of particular structures and assets across multiple views of the pipeline network and related segments, and, as a result, the user may gain a better view of the situation while maintaining the existing filtered configuration (associated with the visualization of hospitals, weather conditions, primary and piggable lines, etc.). Moreover, embodiments may help a user see the criticality of safety and the impact of adverse events in a pipeline network using the PIR functionality among each of the primary pipelines via a customized “heat map” view. That is, the PIR display may let a user quickly understand an area and the potential consequence of negative incidents.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with a pipeline, comprising:
a pipeline status database storing information about the current status of a plurality of pipeline portions comprising the pipeline, each pipeline portion being adapted to transport a substance;
an intelligent pipeline monitoring platform coupled to the pipeline status database, including:
a mapping module to automatically determine location information associated with each of the plurality of pipeline portions, and
a graphical user interface module having access to real world map information; and
a communication port coupled to intelligent pipeline monitoring platform to transmit information creating for a user a visual representation of the plurality of pipeline portions, including information about the current status of at least one pipeline portion, on a graphical user interface map display in accordance with the location information.

2. The system of claim 1, wherein the intelligent pipeline monitoring platform further includes:
an analytic module, having access to historical pipeline information, to generate predictive risk information associated with at least one of the pipeline portions.

3. The system of claim 2, wherein the predictive risk value is based at least in part on a volume of substance transported via the at least one pipeline portion.

4. The system of claim 2, wherein the predictive risk information comprises at least one of: (i) a value, (ii) a category, (iii) a percentage, and (iv) a color.

5. The system of claim 2, wherein the intelligent pipeline monitoring platform further includes:
a user control module to receiving weighing values for risk parameters used by the analytic module.

6. The system of claim 5, wherein at least one of the risk parameters is associated with: (i) a corrosion wall thickness loss, (ii) a pressure change, (iii) weather and flood risk, (iv) earthquake risk, (v) mechanical damage, and (vi) pipeline dent risk.

7. The system of claim 1, wherein the location information is associated with at least one of: (i) pixels, (ii) coordinates, (iii) latitudes and longitudes, (iv) global positioning system information, (v) distances, and (vi) geographic information system data.

8. The system of claim 1, wherein the substance is at least one of: (i) a gas, (ii) propane, (iii) a liquid, and (iv) oil.

9. The system of claim 1, wherein the graphical user interface map display further includes at least one of: (i) topographical information, (ii) a geographic feature, (iii) street information, (iv) population information, (v) weather information, (vi) seismic information, (vii) building information, and (viii) predicted impact radius information.

10. The system of claim 1, wherein the graphical user interface map display further includes, for at least one pipeline segment, at least one of: (i) an anomaly description, and (ii) a work order description.

11. The system of claim 1, wherein the graphical user interface map display further includes an enterprise level active risk value associated with a plurality of different pipelines.

12. The system of claim 1, wherein at least one of the pipeline portions is associated with: (i) a compressor station, (ii) a main line valve, (iii) a field crew, and (iv) a pipeline meter.

13. The system of claim 1, wherein the communication port is adapted to create the visual representation in accordance with a number of different display platforms.

14. A method associated with a pipeline, comprising:
receiving, at an intelligent pipeline management platform, information about a current status of a plurality of pipeline portions, each pipeline portion being adapted to transport a substance;
automatically determining, by a computer processor of the intelligent pipeline management platform, location information associated with each of the plurality of pipeline portions;
automatically generating, by the computer processor, predictive risk information associated with at least one of the pipeline portions based on historical pipeline information and a volume of substance transported via the at least one pipeline portion; and
transmitting information to create a visual representation of the pipeline portions on a graphical user interface map display, in accordance with the location information, including the predictive risk information.

15. The method of claim 14, further comprising:
receiving from a user weighing values for risk parameters used by the analytic module, including at least one weighing value associated with: (i) a corrosion wall thickness loss, (ii) a pressure change, (iii) weather and flood risk, (iv) earthquake risk, (v) mechanical damage, and (vi) pipeline dent risk.

16. The method of claim 14, wherein the graphical user interface map display further includes at least one of: (i) topographical information, (ii) a geographic feature, (iii) street information, (iv) population information, (v) weather information, (vi) seismic information, (vii) building information, and (viii) predicted impact radius information.

17. The method of claim 14, wherein the graphical user interface map display further includes, for at least one pipeline segment, at least one of: (i) an anomaly description, and (ii) a work order description.

18. The method of claim 14, wherein the graphical user interface map display further includes an enterprise level active risk value associated with a plurality of different pipelines.

19. A non-transitory, computer-readable medium storing instructions that, when executed by a computer processor, cause the computer processor to perform a method associated with a plurality of pipeline portions, the method comprising:
receiving, at an intelligent pipeline management platform, information about a current status of a plurality of pipeline portions, each pipeline portion being adapted to transport a substance;
automatically determining, by a computer processor of the intelligent pipeline management platform, location information associated with each of the plurality of pipeline portions;
automatically generating, by the computer processor, predictive risk information associated with at least one of the pipeline portions based on historical pipeline information and a volume of substance transported via the at least one pipeline portion; and
transmitting information to create a visual representation of the pipeline portions on a graphical user interface map display, in accordance with the location information, including the predictive risk information.

20. The medium of claim 19, wherein the method further comprises:
receiving from a user weighing values for risk parameters used by the analytic module, including at least one weighing value associated with: (i) a corrosion wall thickness loss, (ii) a pressure change, (iii) weather and flood risk, (iv) earthquake risk, (v) mechanical damage, and (vi) pipeline dent risk.

21. The medium of claim 19, wherein the graphical user interface map display further includes at least one of: (i) topographical information, (ii) a geographic feature, (iii) street information, (iv) population information, (v) weather information, (vi) seismic information, (vii) building information, (viii) predicted impact radius information, (ix) an anomaly description, and (x) a work order description.
